(19) United States
(12) Patent Application Publication
(10) Pub. No.: US 2025/0036634 A1
(43) Pub. Date: Jan. 30, 2025

(54) SYSTEM FOR COMPUTING AND TRACKING RESOURCE STATE CHANGES USING A MULTICHAIN DISTRIBUTED REGISTER TECHNOLOGY

(71) Applicant: BANK OF AMERICA CORPORATION, Charlotte, NC (US)

(72) Inventors: Petar Evan Puskarich, Murphy, TX (US); Aravind Shankaragouda Singtalur, McKinney, TX (US); Srinath S. Chakravarty, Plano, TX (US); Dinesh Kumar Agrawal, Rowlett, TX (US); Stephen Richard Belton, Garden City, NY (US); Manmohan V. Datla, Frisco, TX (US); Kenneth L. Boyd, Mechanicsville, VA (US); Kerry M. Vaughan, Lawrenceville, NJ (US); Elina Shkodnik, Staten Island, NY (US); Steven Nathan Greene, Scarsdale, NY (US)

(73) Assignee: BANK OF AMERICA CORPORATION, Charlotte, NC (US)

(21) Appl. No.: 18/226,094

(22) Filed: Jul. 25, 2023

(51) Int. Cl. G06F 16/2457; G06F 16/21

(52) U.S. Cl. CPC G06F 16/2457; G06F 16/219

(57) ABSTRACT

A system is provided for computing and tracking resource state changes using a multichain distributed register technology. In particular, the system may comprise an index distributed register that may be stored across a plurality of distributed register nodes. The index distributed register may comprise one or more resource-specific data records that may in turn make up a resource-specific distributed register originating from the index distributed register. The resource-specific distributed register may comprise an initial data record that defines the attributes of the resource, and one or more subsequent data records that may be linked with the initial data record to reflect changes in the state of the resource to be tracked. Based on the data within each of the resource-specific distributed register, the system may compute resource analysis scores and/or trigger real-time user alerts.

### TECHNOLOGICAL FIELD

Example embodiments of the present disclosure relate to a system and method for computing and tracking resource state changes using a multichain distributed register technology.

### BACKGROUND

There is a need for a way to track resource state change data securely and efficiently.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for computing and tracking resource state changes using a multichain distributed register technology. In particular, the system may comprise an index distributed register that may be stored across a plurality of distributed register nodes. The index distributed register may comprise one or more resource-specific data records that may in turn make up a resource-specific distributed register originating from the index distributed register. The resource-specific distributed register may comprise an initial data record that defines the attributes of the resource, and one or more subsequent data records that may be linked with the initial data record to reflect changes in the state of the resource to be tracked. Based on the data within each of the resource-specific distributed register, the system may compute resource analysis scores and/or trigger real-time user alerts. In this way, the system may provide a secure and efficient way to track resource state changes.

Accordingly, embodiments of the present disclosure provide a system for computing and tracking resource state changes using a multichain distributed register technology, the system comprising a processing device; a non-transitory storage device containing instructions when executed by the processing device, causes the processing device to perform the steps of receiving, from a user computing device, a query associated with a resource package comprising one or more resources, wherein the query comprises a unique identifier associated with each of the one or more resources; based on the unique identifier associated with each of the one or more resources, locating one or more data records associated with each of the one or more resources within an index distributed register, wherein each of the one or more data records is an origin data record for a resource-specific distributed ledger; retrieving resource data from each resource-specific distributed ledger; based on the resource data, computing a resource analysis score for each of the one or more resources; and based on computing the resource analysis score, triggering an alert, the alert comprising a notification presented on a display device of the user computing device.

In some embodiments, the query is received based on a user accessing a dashboard using the user computing device, wherein the dashboard comprises one or more interface elements for receiving user inputs relating to the resource package and the one or more resources.

In some embodiments, the query is received in response to detecting that the user is initiating a resource transfer on the user computing device, the resource transfer comprising a transfer of the resource package.

In some embodiments, computing the resource analysis score further comprises computing a composite resource analysis score for the resource package.

In some embodiments, the composite resource analysis score is computed as a weighted average based on the resource analysis score of each of the one or more resources.

In some embodiments, the alert is triggered based on detecting that the resource analysis score falls below a designated threshold associated with the resource.

In some embodiments, computing the resource analysis score is based on a prediction generated by a machine learning algorithm from historical data within the resource-specific distributed ledger.

Embodiments of the present disclosure also provide a computer program product for computing and tracking resource state changes using a multichain distributed register technology, the computer program product comprising a non-transitory computer-readable medium comprising code causing an apparatus to perform the steps of receiving, from a user computing device, a query associated with a resource package comprising one or more resources, wherein the query comprises a unique identifier associated with each of the one or more resources; based on the unique identifier associated with each of the one or more resources, locating one or more data records associated with each of the one or more resources within an index distributed register, wherein each of the one or more data records is an origin data record for a resource-specific distributed ledger; retrieving resource data from each resource-specific distributed ledger; based on the resource data, computing a resource analysis score for each of the one or more resources; and based on computing the resource analysis score, triggering an alert, the alert comprising a notification presented on a display device of the user computing device.

In some embodiments, the query is received based on a user accessing a dashboard using the user computing device, wherein the dashboard comprises one or more interface elements for receiving user inputs relating to the resource package and the one or more resources.

In some embodiments, the query is received in response to detecting that the user is initiating a resource transfer on the user computing device, the resource transfer comprising a transfer of the resource package.

In some embodiments, computing the resource analysis score further comprises computing a composite resource analysis score for the resource package.

In some embodiments, the composite resource analysis score is computed as a weighted average based on the resource analysis score of each of the one or more resources.

In some embodiments, the alert is triggered based on detecting that the resource analysis score falls below a designated threshold associated with the resource.

Embodiments of the present disclosure also provide a computer-implemented method for computing and tracking resource state changes using a multichain distributed register technology, the computer-implemented method comprising receiving, from a user computing device, a query associated with a resource package comprising one or more resources, wherein the query comprises a unique identifier associated with each of the one or more resources; based on the unique identifier associated with each of the one or more resources, locating one or more data records associated with each of the one or more resources within an index distributed register, wherein each of the one or more data records is an origin data record for a resource-specific distributed ledger; retrieving resource data from each resource-specific distributed ledger; based on the resource data, computing a resource analysis score for each of the one or more resources; and based on computing the resource analysis score, triggering an alert, the alert comprising a notification presented on a display device of the user computing device.

In some embodiments, the query is received based on a user accessing a dashboard using the user computing device, wherein the dashboard comprises one or more interface elements for receiving user inputs relating to the resource package and the one or more resources.

In some embodiments, the query is received in response to detecting that the user is initiating a resource transfer on the user computing device, the resource transfer comprising a transfer of the resource package.

In some embodiments, computing the resource analysis score further comprises computing a composite resource analysis score for the resource package.

In some embodiments, the composite resource analysis score is computed as a weighted average based on the resource analysis score of each of the one or more resources.

In some embodiments, the alert is triggered based on detecting that the resource analysis score falls below a designated threshold associated with the resource.

In some embodiments, computing the resource analysis score is based on a prediction generated by a machine learning algorithm from historical data within the resource-specific distributed ledger.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for computing and tracking resource state changes using a multichain distributed register technology, in accordance with an embodiment of the disclosure;

FIG. 2A illustrates an exemplary DLT architecture, in accordance with an embodiment of the disclosure;

FIG. 2B illustrates an exemplary transaction object within the DLT architecture, in accordance with an embodiment of the disclosure;

FIG. 3A illustrates an exemplary process of creating an NFT 300, in accordance with an embodiment of the disclosure;

FIG. 3B illustrates an exemplary NFT as a multi-layered documentation of a resource, in accordance with an embodiment of the disclosure; and

FIG. 4 illustrates a method for computing and tracking resource state changes using a multichain distributed register technology, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, investment vehicles, cryptographic and/or digital currencies, and/or the like. In yet other embodiments, the resources may include real-world goods or commodities that may be acquired and/or exchanged by a user.

“Cryptographic hash function” or “hash algorithm” as used herein may refer to a set of logical and/or mathematical operations or processes that may be executed on a specified segment of data to produce a hash output. Given a specified data input, the hash algorithm may produce a cryptographic hash output value which is a fixed-length character string. Examples of such hash algorithms may include MD5, Secure Hash Algorithm/SHA, or the like. According, “hashing” or “hashed” as used herein may refer to the process of producing a hash output based on a data input into a hash algorithm.

“Public-key cryptography” or “asymmetric cryptography” may refer to a process for data encryption and/or verification by which a pair of asymmetric corresponding cryptographic keys are generated (e.g., a “key pair” comprising a “public key” intended to be distributed and a “private key” intended to be possessed by a single user or device). Data encrypted using a public key may be decrypted only by the possessor of the corresponding private key. Furthermore, data signed with a private key may be validated by the possessor of the corresponding public key to verify the identity of the signer (which may be referred to herein as “digital signing”).

With the proliferation of computing and networking technologies, resources may be freely acquired and/or transferred between entities. In many cases, certain resources may be bundled or packaged with other resources as part of the resource transactions that may occur between entities, where each resource may have unique attributes or characteristics. For instance, a certain resource that may carry a higher probability of adverse outcomes for the recipient of the resource may be packaged with numerous other resources that may be transferred to the recipient. As a result, the resource in question may be “hidden” within the package of resources such that the outcome or consequence of receiving the resource may not be realized or appreciated by the receiving entity. Furthermore, the resource may experience state changes over time, which may in turn create fluctuations in the probability of adverse outcomes for the recipient. Accordingly, there is a need for a way to securely and efficiently track and assess resources on a real-time basis.

To address the above concerns among others, the system described herein provides a way to compute and track resource state changes using a multichain distributed register technology. The system may comprise a distributed register (or a distributed ledger) that may be hosted on a plurality of distributed servers or computing devices (which may be referred to herein as “nodes” or “distributed register nodes”). The distributed register may be, in some embodiments, an index distributed ledger that serves as an index of one or more resources that may be tracked by the system. For instance, an index distributed ledger may be generated to store information regarding all of the resources that may potentially be acquired and/or transferred by an entity (e.g., a user, an organization, and/or the like). In this regard, each of the transaction objects (which may also be referred to herein as “data records”) within the index distributed ledger may be define a resource to be tracked by the entity, where each data record may comprise data regarding one or more attributes of the resource. Examples of such attributes may include a resource name or identifier, resource ownership information, transferor and/or transferee information, initial resource ratings, and/or the like.

The system may comprise a data intake engine, which may comprise data crawlers, data scrapers, and/or the like that may receive data (e.g., data relating to the resource) from one or more data sources, such as intelligence feeds, internal and/or third-party resource databases, web pages and/or web-hosted data, and/or the like. Accordingly, the system may, upon receiving new data regarding a particular resource, add updated data records containing the new data to the index distributed ledger. In this regard, each of the data records within the index distributed ledger may serve as an origin data record for a new distributed ledger that may be specific to the resource (e.g., a “resource-specific distributed ledger” or “resource distributed ledger”). As new data regarding a particular resource is received through the data intake engine, the system may append a data record to the end of the appropriate resource-specific distributed ledger. In this way, the index distributed ledger may have one or more sub-ledgers (e.g., the resource-specific distributed ledgers) that may branch off from the data records of the index distributed ledger, where each of the sub-ledgers track all of the state changes of a particular resource over time.

For each of the resources tracked by the system, the system may compute a resource analysis score, where the resource analysis score indicates the level of safety associated with transferring and/or receiving the resource. To this end, the system may traverse the resource distributed ledger associated with the resource and access the data records stored within the resource distributed ledger. Based on such data records, which may contain information regarding the attributes of the resource, up-to-date state information of the resource, resource state changes over time, and/or the like, the system may compute the resource analysis score associated with the resource. In one embodiment, the system may detect that the resource analysis score has dropped below a designated threshold associated with the resource, which may indicate that the resource may be unsafe to transfer or receive (e.g., potential adverse outcomes may result from transferring or receiving the resource).

In some embodiments, the system may further compute a resource analysis score for a resource package or bundle, where the resource package or bundle may comprise multiple resources that may be transferred or received together within a single transaction. In such an embodiment, the resource analysis score for the resource package may be computed as a composite resource analysis score that may be based on the individual resource analysis scores for each of the resources that are included in the resource package as well as the proportion or percentage of each resource with respect to the total resource package. For instance, if Resource A has a resource analysis score of 73 and comprises 30% of the resource package, and Resource B has a resource analysis score of 30 and comprises 70% of the resource package, the composite resource analysis score for the total resource package may be computed as a weighted average based on each the individual resource scores (e.g., 73, 30) multiplied by their respective proportions or ratios (e.g., 30%, 70%). In this way, the system may further provide insights into the potential outcomes of transferring or receiving a resource package.

The system may comprise a user dashboard that may be accessed by one or more users (e.g., through a user computing device). The dashboard may comprise one or more interface elements to accept inputs from and provide outputs to the user. In this regard, the user may access the dashboard to submit a query regarding a request to compute a resource analysis score for a particular resource package. In response, the system may traverse the index distributed ledger along with the various subchains (e.g., the resource-specific distributed ledgers for the resources within the resource package) to compute the individual resource analysis scores for the various resources in the resource package, and based on the individual resource analysis scores, compute a composite analysis score for the resource package. In other embodiments, the system may periodically (e.g., every day, every hour, and/or the like) compute resource analysis scores on an ongoing basis. The individual resource analysis scores as well as the total composite resource analysis score for the package may be displayed on the dashboard to the user.

In some embodiments, the system may be configured to trigger the transmission of real-time alerts to the user computing device based on detecting certain conditions with respect to the resources tracked by the system. For instance, the system may detect that the resource analysis score for a particular resource or resource package is below a certain threshold. In such a scenario, the system may trigger an alert (e.g., a notification comprising a text alert, audio alert, image-based alert, and/or the like) that may be presented to the user (e.g., through the dashboard), where the alert indicates that the transfer or acquisition of the resource may lead to adverse outcomes. In some embodiments, an alert may also be automatically transmitted to the user computing device if the system detects a change in a status of a resource that causes the resource analysis score to drop below the designated threshold. For instance, a resource may experience one or more state changes over time that affect the resource analysis score. Accordingly, the system may transmit a real-time alert to the user computing device, thereby notifying the user with time-sensitive information.

An exemplary embodiment is described below for illustrative purposes only and should not be construed as restricting the scope of the disclosure provided herein. In one embodiment, the user may be a business organization that may be interested in acquiring an investment portfolio (e.g., a resource package) that may comprise one or more investments (e.g., resources), such as stocks, bonds, futures, certificates of deposit (“CDs”), real estate, digital currencies, and/or the like. The user may log onto the dashboard to submit a query to the system regarding the resource package. For instance, the user may wish to assess the possibility of certain resources within the resource package leading to undesirable economic outcomes if the user were to acquire the resource. Accordingly, the query may identify the resource package and/or the constituent resources that make up the resource package.

The system, upon receiving the query, may search the index distributed ledger for entries that match the resource and/or resource packages identified in the query. In this regard, each of the resources and/or resource packages may be associated with a unique identifier (e.g., a cryptographic hash value). The system may then retrieve the data records from each of the resource distributed ledgers associated with each of the resources and compute the resource analysis scores for each of the resources based on the information in the data records. Once the resource analysis scores have been calculated, the system may present the scores to the user through the dashboard along with any alerts that have been generated. For example, the system may detect that the resource analysis score for a particular stock within the investment portfolio has fallen below a certain threshold (e.g., where such score may be computed based on news feeds, intelligence feeds, agency reporting data, internal ratings or assessments, and/or the like). For instance, the stock may have a dilution ratio (e.g., 70%) that causes the resource analysis score to drop below the designated threshold. Based on detecting that the score has fallen below the threshold, the system may determine that the stock carries a high probability of loss. Accordingly, in some embodiments, the alert may take the form of a notification displayed on the dashboard to the user. In this way, the system may provide entities with an efficient way to identify potentially problematic resources.

The system as described herein provides a number of technological benefits over conventional systems for tracking resources. In particular, by using a branching distributed ledger structure comprising an index distributed ledger and one or more resource-specific distributed ledgers, the system may have a durable, secure way to store resource-specific data as well as resource state changes over time. In turn, storing the resource-specific data in this manner allows the system to quickly compute resource analysis scores for all of the resources within a particular resource package, which prevents the transfer or acquisition of resources that may lead to potentially undesirable outcomes.

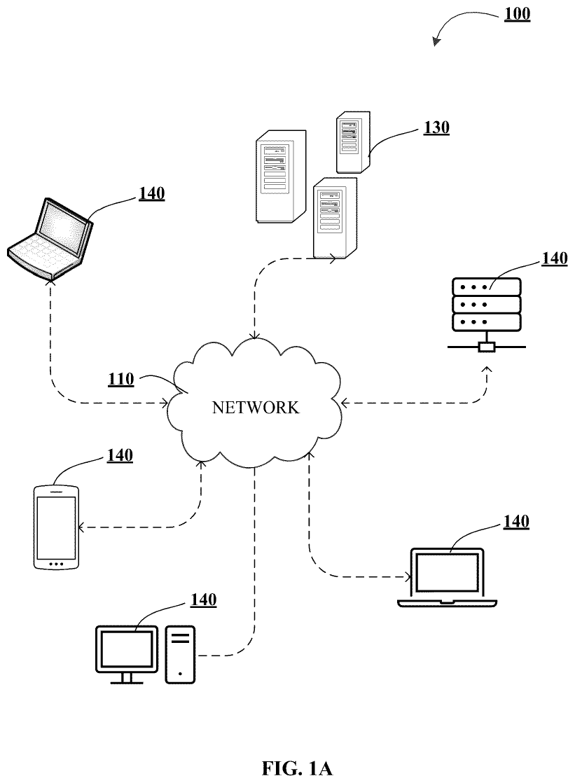

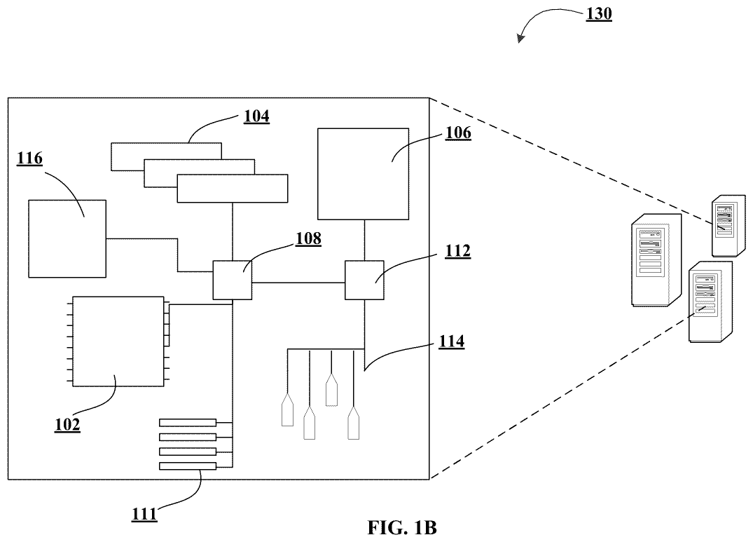

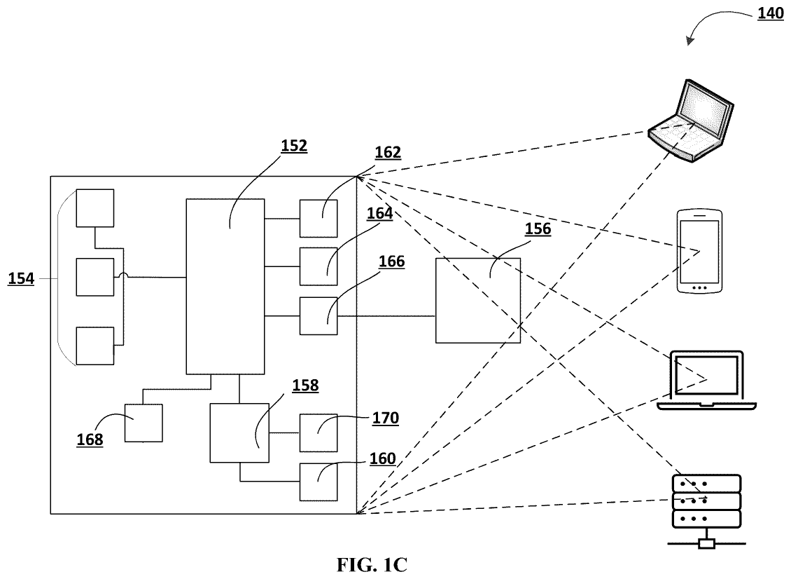

FIGS. 1A-1C illustrate technical components of an exemplary distributed computing environment 100 for the system for computing and tracking resource state changes using a multichain distributed register technology, in accordance with one embodiment of the present disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

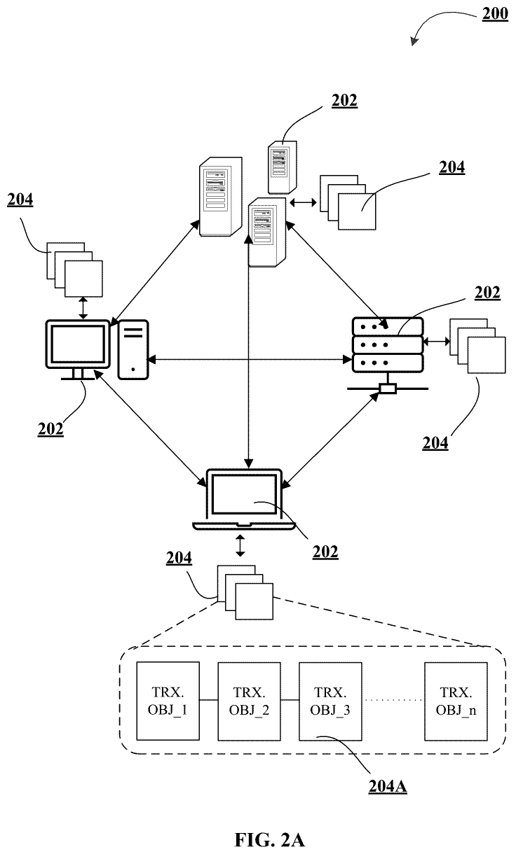

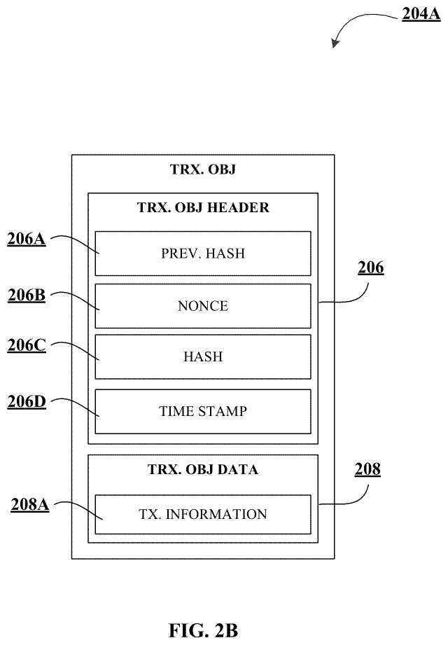

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT may use a peer-to-peer protocol for a cryptographically secured distributed ledger of transactions represented as transaction objects (which may also be referred to herein as “data records”) that are linked. In some embodiments, the transaction objects or data records may contain state information about a resource that is tracked by the system. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT may use smart contracts. “Smart contracts” as used herein may refer to computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A “public distributed ledger” as referred to herein may refer to a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, a fully private distributed ledger may be a distributed ledger whereby permissions are kept centralized with one entity. The permissions may be public or restricted to an arbitrary extent. And lastly, a consortium distributed ledger may be a distributed ledger where the consensus process is controlled by a pre-selected set of nodes; for example, a distributed ledger may be associated with a number of member institutions (e.g., 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes. The transaction objects 204A may comprise an origin transaction object that may serve as the beginning of a chain of transaction objects, such that transaction objects 204A are added to the end of the chain beginning from the origin transaction object. In some embodiments, a subchain may be formed from any of the transaction objects 204A within the distributed ledger 204, where the subchain may comprise information relating to a specific resource tracked by the system.

As shown in FIG. 2B, an exemplary transaction object 204A may include a transaction header 206 and a transaction object data 208. The transaction header 206 may include a cryptographic hash of the previous transaction object 206A, a nonce 206B-a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

An NFT is a cryptographic record (referred to as “tokens”) linked to a resource. An NFT is typically stored on a distributed ledger that certifies ownership and authenticity of the resource, and exchangeable in a peer-to-peer network.

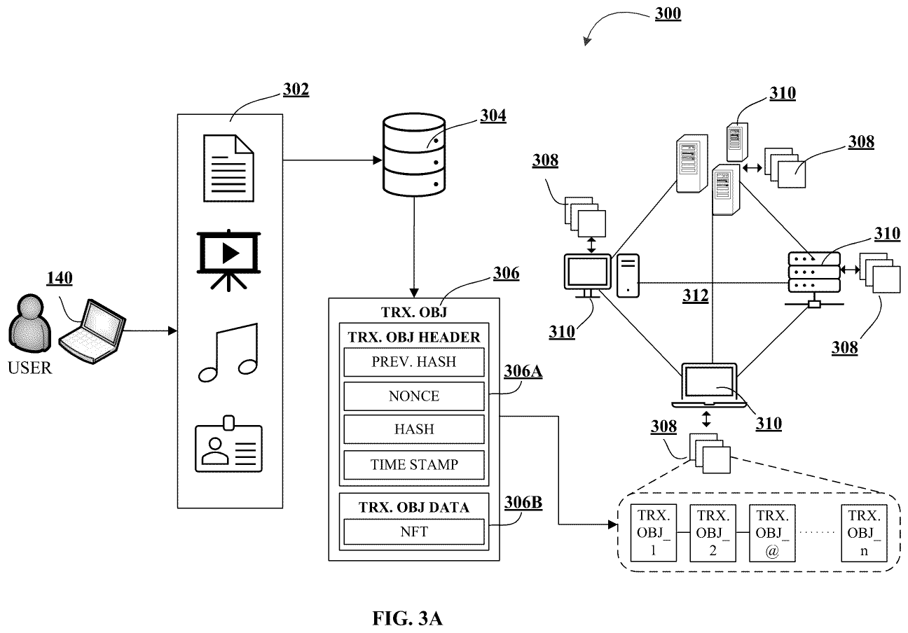

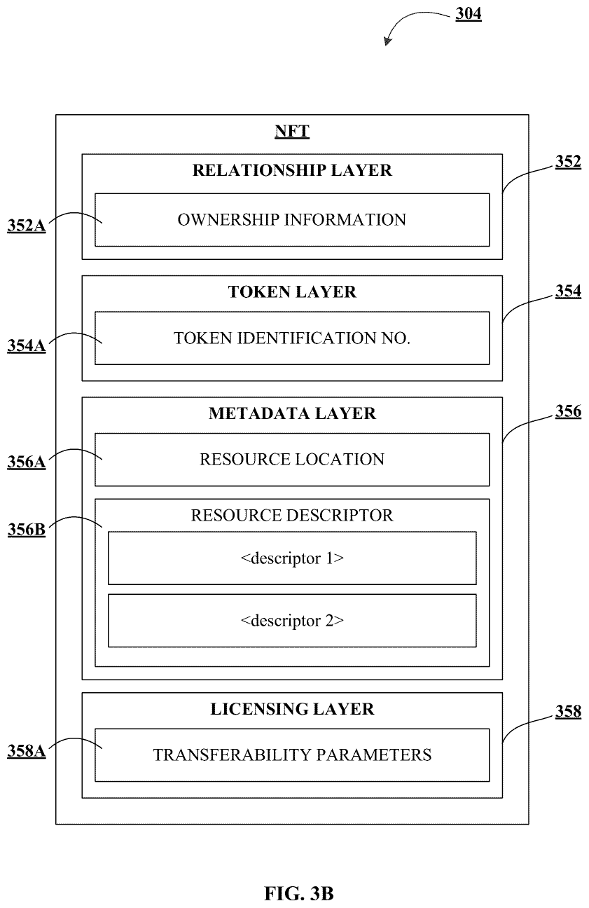

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, virtual world items, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce-a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. The transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process

As shown in FIG. 3A, the distributed ledger 308 may be maintained on multiple devices (nodes) 310 that are authorized to keep track of the distributed ledger 308. For example, these nodes 310 may be computing devices such as system 130 and end-point device(s) 140. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S1, the relationship between B1 and S1 as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

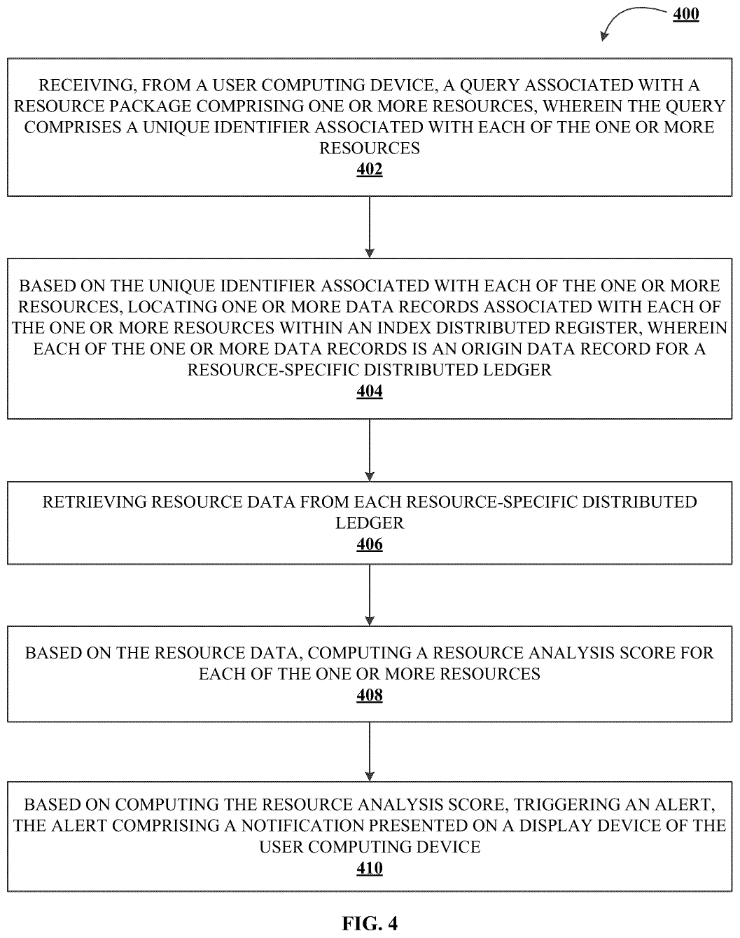

FIG. 4 illustrates a method 400 for computing and tracking resource state changes using a multichain distributed register technology, in accordance with an embodiment of the disclosure. As shown in block 402, the method includes receiving, from a user computing device, a query associated with a resource package comprising one or more resources, wherein the query comprises a unique identifier associated with each of the one or more resources. A user may submit a query by logging onto the dashboard using the user computing device, where the dashboard may comprise one or more interface elements through which the user may provide information about the resource package and/or the resources included therein. For example, in one embodiment, the user may select and identify the resources by searching for the resources within a drop-down menu. In other embodiments, the user may enter at least a partial search term associated with the resource (e.g., into a text entry field of the dashboard). The user may further enter the amounts or proportions of each resource within the resource package (e.g., percentages, flat values, and/or the like). In other embodiments, the system may automatically retrieve the amounts or proportions of each resource based on identifying the resource package (e.g., by retrieving data from internal or third-party databases regarding the resource package). In yet other embodiments, the query may be automatically transmitted to the system upon the user initiating a transfer of resources using the user computing device (e.g., a proposed acquisition of the resource package).

Next, as shown in block 404, the method includes, based on the unique identifier associated with each of the one or more resources, locating one or more data records associated with each of the one or more resources within an index distributed register, wherein each of the one or more data records is an origin data record for a resource-specific distributed ledger. The index distributed register may comprise a chain of data records (e.g., a blockchain structure), where each of the data records uniquely identify a resource that may be tracked by the system. In this regard, each data record within the index distributed ledger (or “index data record”) may serve as the starting point for another blockchain that is specific to the resource. Accordingly, the index data records may comprise one or more attributes of the resource, such as the resource name or identifier, current resource state, initial rating score, and/or the like.

As new information regarding each resource is collected by the system (e.g., through data crawlers, data feeds, and/or the like), the system may append blocks to the resource-specific distributed ledger containing information regarding the state changes of the resource. For instance, if the resource is an investment vehicle that has experienced a recent dilution, information about such a state change may be added to the resource-specific distributed ledger associated with that particular resource. In this way, the data regarding each of the resources may be stored within a multichain system comprising the index distributed ledger and the various resource-specific distributed ledgers.

Next, as shown in block 406, the method includes retrieving resource data from each resource-specific distributed ledger. The resource data may include all of the data stored across the entire resource-specific chain associated with the resource. Accordingly, the resource data may include a complete history of the various state changes of the resource over time. The resource data may be retrieved by the system by traversing each of the blocks or data records within each of the resource-specific distributed ledgers associated with the resources that are part of the resource package designated by the user.

Next, as shown in block 408, the method includes, based on the resource data, computing a resource analysis score for each of the one or more resources. The resource analysis score may be computed based on various factors, such as the resource type, resource owner, transaction history, current resource values, and/or the like. As such, the resource analysis score may reflect the likelihood that acquisition of the resource may result in undesirable outcomes for the acquiring entity (e.g., higher resource analysis scores may indicate a lower likelihood, whereas lower resource analysis scores may indicate a higher likelihood).

In some embodiments, computing the resource analysis score may further comprise computing a composite resource analysis score for the resource package. In this regard, the composite score may be based on the individual resource analysis scores for each of the resources in the resource package along with the ratios or proportions of each resource within the resource package. Accordingly, in some embodiments, the composite resource analysis score may be computed as a weighted average calculated based on a sum of the individual resource values, where each of the individual resource values may be multiplied by their weight (e.g., the percentage of the total resource package that the individual resource comprises).

In some embodiments, computing the resource analysis score for each resource may comprise using a machine learning algorithm to analyze the historical data from the resource-specific distributed ledger and generate a projection for a value of the resource. Based on the projection, the system may adjust the resource analysis score for the resource. For instance, the system may project that, based on historical activity associated with the resource, that the value of the resource will drop in the future. In such a scenario, the system may adjust the resource analysis score downward for the particular resource.

Next, as shown in block 410, the method includes, based on computing the resource analysis score, triggering an alert, the alert comprising a notification presented on a display device of the user computing device. In some embodiments, triggering the alert may be executed in response to detecting that the resource analysis score for a particular resource has dropped below a designated threshold. The alert may be triggered based on a threshold set for any individual resource analysis score as well as the composite resource analysis score. In an exemplary embodiment, the user may have initiated a resource transfer (e.g., an acquisition of a resource package). Based on computing the resource analysis scores for the resource package, the system may determine that the resource analysis score for a particular resource in the resource package and/or the composite resource analysis score for the resource package itself has fallen below their respective designated threshold. In response, the system may trigger an alert which causes a pop-up notification to appear on the interface of the user computing device, where the notification may include the resource analysis scores along with a message that the scores have fallen below a threshold. In this way, the system may provide the user with time-sensitive data regarding the resources that the user is seeking to acquire or transfer.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for computing and tracking resource state changes using a multichain distributed register technology, the system comprising:
a processing device;
a non-transitory storage device containing instructions when executed by the processing device, causes the processing device to perform the steps of:
receiving, from a user computing device, a query associated with a resource package comprising one or more resources, wherein the query comprises a unique identifier associated with each of the one or more resources;
based on the unique identifier associated with each of the one or more resources, locating one or more data records associated with each of the one or more resources within an index distributed register, wherein each of the one or more data records is an origin data record for a resource-specific distributed ledger;
retrieving resource data from each resource-specific distributed ledger;
based on the resource data, computing a resource analysis score for each of the one or more resources; and
based on computing the resource analysis score, triggering an alert, the alert comprising a notification presented on a display device of the user computing device, wherein the alert is a real-time alert triggered based on detecting that the resource analysis score falls below a designated threshold associated with the resource, wherein the notification is a pop-up notification comprising the resource analysis score and a message indicating that the resource analysis score has fallen below the designated threshold and that the one or more resources are unsafe to transfer or receive.

2. The system of claim 1, wherein the query is received based on a user accessing a dashboard using the user computing device, wherein the dashboard comprises one or more interface elements for receiving user inputs relating to the resource package and the one or more resources.

3. The system of claim 1, wherein the query is received in response to detecting that the user is initiating a resource transfer on the user computing device, the resource transfer comprising a transfer of the resource package.

4. The system of claim 1, wherein computing the resource analysis score further comprises computing a composite resource analysis score for the resource package.

5. The system of claim 4, wherein the composite resource analysis score is computed as a weighted average based on the resource analysis score of each of the one or more resources.

6. (canceled)

7. The system of claim 1, wherein computing the resource analysis score is based on a prediction generated by a machine learning algorithm from historical data within the resource-specific distributed ledger.

8. A computer program product for computing and tracking resource state changes using a multichain distributed register technology, the computer program product comprising a non-transitory computer-readable medium comprising code causing an apparatus to perform the steps of:
receiving, from a user computing device, a query associated with a resource package comprising one or more resources, wherein the query comprises a unique identifier associated with each of the one or more resources;
based on the unique identifier associated with each of the one or more resources, locating one or more data records associated with each of the one or more resources within an index distributed register, wherein each of the one or more data records is an origin data record for a resource-specific distributed ledger;
retrieving resource data from each resource-specific distributed ledger;
based on the resource data, computing a resource analysis score for each of the one or more resources; and
based on computing the resource analysis score, triggering an alert, the alert comprising a notification presented on a display device of the user computing device, wherein the alert is a real-time alert triggered based on detecting that the resource analysis score falls below a designated threshold associated with the resource, wherein the notification is a pop-up notification comprising the resource analysis score and a message indicating that the resource analysis score has fallen below the designated threshold and that the one or more resources are unsafe to transfer or receive.

9. The computer program product of claim 8, wherein the query is received based on a user accessing a dashboard using the user computing device, wherein the dashboard comprises one or more interface elements for receiving user inputs relating to the resource package and the one or more resources.

10. The computer program product of claim 8, wherein the query is received in response to detecting that the user is initiating a resource transfer on the user computing device, the resource transfer comprising a transfer of the resource package.

11. The computer program product of claim 8, wherein computing the resource analysis score further comprises computing a composite resource analysis score for the resource package.

12. The computer program product of claim 11, wherein the composite resource analysis score is computed as a weighted average based on the resource analysis score of each of the one or more resources.

13. (canceled)

14. A computer-implemented method for computing and tracking resource state changes using a multichain distributed register technology, the computer-implemented method comprising:
receiving, from a user computing device, a query associated with a resource package comprising one or more resources, wherein the query comprises a unique identifier associated with each of the one or more resources;
based on the unique identifier associated with each of the one or more resources, locating one or more data records associated with each of the one or more resources within an index distributed register, wherein each of the one or more data records is an origin data record for a resource-specific distributed ledger;
retrieving resource data from each resource-specific distributed ledger;
based on the resource data, computing a resource analysis score for each of the one or more resources; and
based on computing the resource analysis score, triggering an alert, the alert comprising a notification presented on a display device of the user computing device, wherein the alert is a real-time alert triggered based on detecting that the resource analysis score falls below a designated threshold associated with the resource, wherein the notification is a pop-up notification comprising the resource analysis score and a message indicating that the resource analysis score has fallen below the designated threshold and that the one or more resources are unsafe to transfer or receive.

15. The computer-implemented method of claim 14, wherein the query is received based on a user accessing a dashboard using the user computing device, wherein the dashboard comprises one or more interface elements for receiving user inputs relating to the resource package and the one or more resources.

16. The computer-implemented method of claim 14, wherein the query is received in response to detecting that the user is initiating a resource transfer on the user computing device, the resource transfer comprising a transfer of the resource package.

17. The computer-implemented method of claim 14, wherein computing the resource analysis score further comprises computing a composite resource analysis score for the resource package.

18. The computer-implemented method of claim 17, wherein the composite resource analysis score is computed as a weighted average based on the resource analysis score of each of the one or more resources.

19. (canceled)

20. The computer-implemented method of claim 14, wherein computing the resource analysis score is based on a prediction generated by a machine learning algorithm from historical data within the resource-specific distributed ledger.
